(19) United States
(12) Patent Application Publication
(10) Pub. No.: US 2006/0124541 A1
(43) Pub. Date: Jun. 15, 2006

(54) Treatment of waste activated sludge

(75) Inventors: Peter Alan Logan, Queensland (AU); Ian Robert Jones, Queensland (AU)

Correspondence Address: BIRCH STEWART KOLASCH & BIRCH, PO BOX 747, FALLS CHURCH, VA, 22040-0747, US

(73) Assignee: Fungi-Gulp Pty LTD, Manly (AU)

(21) Appl. No.: 10/529,596

(22) PCT Filed: Sep. 30, 2002
(86) PCT No.: PCT/AU02/01330

§ 371 Date: Oct. 17, 2005

(51) Int. Cl. C02F 3/28

(52) U.S. Cl. 210/605

(57) ABSTRACT

A process for treatment of waste activated sludge from a BNR process, which includes the steps of: (a) concentration of the activated sludge from a total solids content (dry weight) of 0.1-1.0% w/v to an increased solids content of 1.5-5.0% w/v, wherein said solids largely contain bacterial biomass from prior aeration of the activated sludge; (b) disrupting bacterial cells contained in the biomass so as to release fermentable nutrients from said bacterial cells; (c) passing the activated sludge from step (b) through an anaerobic digester system; and (d) removing N and/or P from the residue obtained after step (c).

THIS INVENTION relates to a process for treatment of waste activated sludge from a biological nutrient removal (BNR) sewage treatment plant.

### BACKGROUND ART

Conventional sewage treatment processes are usually applied to domestic or industrial wastewater and are used in treatment plants that include anaerobic digesters for sludge treatment. In such treatment plants, there are provided sidestreams, or “return liquors” which are flows of wastewater that originate from digested sludge dewatering equipment such as centrifuges or belt filter presses. The filtrate from such equipment is typically very high in ammonia and phosphorous because these compounds are released in the anaerobic digestion process. If the liquid from the sludge digestion process is returned to the head of the plant, most of the phosphorous is only recirculated and not removed.

In a document entitled “Controlled Struvite Crystallisation for Removing Phosphorous from Anaerobic Digester Sidestreams” by Elisabeth v Münch and Keith Barr, and obtainable from Brisbane Water, 240 Donaldson Road, Rocklea, Queensland, 4106, Australia, it has been proposed to insert a continuously operated MAP reactor into the abovementioned sidestreams using struvite crystallisation. Struvite or magnesium ammonium phosphate (MAP) is a naturally occurring crystal of MAP. Struvite can be used for effective removal of both N and P.

Reference also may be made to International Publication WO 02/36502 which refers to a waste treatment process, which includes the steps of:

(a) initial processing of waste including faeces which is passed through a hydrocyclone or centrifugal separator to remove large foreign objects;

(b) use of a macerator pump for transporting waste from a loading bay to one or more holding tanks;

(c) separation of the waste into a predominantly liquid component and a predominantly solids component. The predominantly liquid component is transported to a holding tank or lagoon for subsequent removal of N and P by use of, for example, addition of magnesium hydroxide to the waste which will react with any N or P present to cause precipitation of struvite;

(d) the predominantly solid component is then passed through a plurality of anaerobic bioreactors followed by subsequent removal of N and P as described above in step (c) before filtration and subsequent splitting of the solid component for use as compost or soil and a liquid component which is then aerated and passed to a holding tank or lagoon.

The above conventional waste treatment processes show that it is well known to remove phosphorous and nitrogen from the waste being treated, wherein such processes produce as end products an inactive solid component or sludge which is disposed of in landfills or on agricultural land and a liquid component which is disposed of in holding lagoons. However, of particular relevance to the present invention is a BNR sewage treatment process, which contrasts from conventional waste treatment processes in that the most significant end product is waste activated sludge (WAS) which includes a high proportion of biomass.

In an example of a conventional BNR process, a typical BNR treatment plant will include sewage or influent being fed into a primary screening process for removal of debris and grit before the influent is introduced into biological reactors which include four separate zones. The influent is mixed with return active sludge (RAS) containing micro-organisms, which is returned from a clarifier or settling tank located upstream of the biological reactors. The four zones include a denitrification zone which removes nitrates from the RAS before it is mixed with the influent. This zone is deficient in dissolved oxygen so that the micro-organisms utilize the nitrates thereby consuming chemically combined oxygen and releasing nitrogen gas to atmosphere.

Subsequently, the raw sewage or influent combined with RAS flows into an anaerobic zone wherein phosphorous is released from the bacterial cells because of the lack of oxygen which is not available for bacterial respiration. In this zone, fine particles in the raw sewage stream begin to clump or floc.

The sewage, after being processed in the anaerobic zone, may then be passed to the anoxic zone. The sewage is now rich in oxidised nitrogen compounds such as nitrites and nitrates and is thus denitrified in the anoxic zone reducing the total nitrogen level in the effluent.

Finally, there is provided an aeration zone which receives the sewage after denitrification in the anoxic zone. In this zone, air is bubbled through fine bubble diffusers that raise the dissolved oxygen level to 1 mg/litre. This facilitates the growth of organisms that consume or breakdown the complex organic compounds in the sewage to CO₂ and water and promote the nitrification of nitrogen compounds such as ammonia to nitrites and nitrates. In this zone, which is an oxygen rich environment, the bacteria previously depleted of phosphorous uptake more phosphorous than was previously released in the anaerobic zone, thereby providing a net reduction of the phosphorous in the wastewater.

Subsequently, the influent is passed through the clarifier so as to allow the suspended activated sludge to settle at the bottom before part thereof being recycled to the denitrification zone. The remainder of the activated sludge (WAS) is transported to a belt press for de-watering purposes. The treated waste may then be passed to an effluent lagoon after being disinfected.

A particular disadvantage that has been relevant to a conventional BNR process, as described above, is the problem of disposal of the waste activated sludge that is generated from this process. Such activated sludge has a high proportion of gram negative aerobic bacteria and Enterobacteriaceae and such bacteria can still include pathogens such as E. coli, Salmonella, Shigella and faecal coliforms generally. In the conventional BNR process, as described above, the biomass in the activated sludge will also include N and P which has been removed from the influent during passage through the BNR plant. The sludge will also have a minor proportion of lignocellulose and other insoluble material which remains in suspension. The presence of biomass in the sludge makes the sludge unstable and it is odorous, biologically active, cannot be stockpiled and is very difficult and expensive to process into a reusable form. Ideally, such sludge could be used as a soil conditioner or fertilizer. However, in practice, this requires special approval for each site which is difficult and expensive to obtain.

Solutions that have been considered in relation to satisfactory disposal of such sludge have included (i) incineration, (ii) very large drying beds, (iii) heating the sludge by electrically operated or gas powered heaters and subsequent steam drying to above 60% solids, (iv) aerobic digestion in combination with drying beds, (v) worm farms, (vi) soil injection, (vii) mixing with soil to produce topsoil, (viii) composting in various forms, (ix) burial, and (x) use of cement and/or lime stabilisation. However, none of these solutions have proven to be cost effective.

### OBJECT OF THE INVENTION

It is therefore an object of the invention to provide a method that will satisfactorily dispose of activated sludge from BNR plants.

The process of the invention includes the following steps:

(1) concentration of waste activated sludge from a BNR process from a total solids content (dry weight) of 0.1-1.0% w/v to an increased solids content of 1.5-5.0% w/v, wherein said solids largely contain bacterial biomass from prior aeration of the activated sludge;

(2) disrupting bacterial cells contained in the biomass so as to release fermentable nutrients from said bacterial cells;

(3) passing the activated sludge from step (2) through an anaerobic bioreactor system; and

(4) removing phosphorous and/or nitrogen from the residue obtained after step (3).

Also, prior to step (4), strong acid may be added to the activated waste to kill bacterial pathogens present in the bacterial biomass.

The activated sludge is obtained from a conventional BNR process as described above and, as such, will contain bacterial biomass which may be represented by gram negative aerobic bacteria of the type represented in Table 1 herein or gram negative Enterobacteriaceae which may be represented by bacteria shown in Table 2 herein. Such sludge will have already been subjected to an aeration process as discussed previously in relation to a conventional BNR process.

Preferably, the activated sludge will have around 0.4% total solids dry weight prior to step (1) and will have 2-4% total solids content after step (1).

The concentration step may be carried out by filtration or have a flocculating agent added thereto, such as polyacrylamide, ferric chloride or alum to enhance concentration of the activated waste. Other methods of concentration are discussed hereinafter.

The concentration procedure may also include passing the waste material over a screen, which is subject to the action of wash water above and below the screen, to prevent clogging or blockages occurring in pores or passages located in the screen. Preferably, use may be made of a filter system known as the BALEEN filter system, which is described in International Publication 98/23357, which is incorporated herein by reference.

The disruption step (2) may be carried out by any suitable technique which lyses or disrupts the bacterial cells such as strong agitation or being passed through a mascerator pump.

The masceration step may take a period of 5-48 hours and, more preferably, 24 hours and, preferably, employs a submersible pump having an impeller with cutters on the impeller to disrupt microbial or bacterial cells contained in the sludge. Most preferably, the sludge is passed through a cutter plate having a plurality of apertures which is preferably stationary with a rotatable cutter attached to and rotating with respect to the stationary cutter head. The cutter plate may be in the shape of a disc of annular shape with the apertures located in the disc at spaced intervals. The apertures may have a diameter of 5-15 mm and, more suitably, 10 mm. The rotatable cutter may be provided with a plurality of lobes with the edges of each lobe constituting cutting teeth or cutting edges. Each of the rotatable cutter and cutting plate may be mounted to a suitable support shaft which is co-axial thereto.

The abovementioned masceration step suitably brings about disruption or lysis of the bacterial cells present in the biomass sludge and, thus, the average particle size of the biomass may be reduced from 50-100 microns to 0.1-5 microns. Suitably, the biomass may constitute 30-70% of the particles in the solid component of the sludge and, more preferably, 50-70%.

The sludge after masceration, in some circumstances, will have a pH of around 6.0-7.5 and, thus, may have to be subjected to a pH lowering step when passing through the anaerobic bioreactor system. More preferably, the pH lowering step will take place in a final bioreactor of the bioreactor system. However, it will be appreciated that the pH lowering step may be applied to other bioreactors. However, it will be appreciated that, in some circumstances, because of the nature of the activated sludge, a pH lowering step may not be necessary.

Usually, the pH lowering step will involve the addition of a strong mineral acid, such as hydrochloric acid, sulphuric acid or nitric acid. However, this does not preclude the use of other acids, such as phosphoric acid, perchloric acid or strong organic acids, which will achieve the same effect.

The bioreactor system may comprise a plurality of bioreactors as described in WO 95/25071, the contents of which are totally incorporated herein by reference.

However, as in the case of WO 95/25071, each bioreactor may be interconnected by an overflow conduit so that waste material or effluent is quickly and efficiently transferred from one bioreactor to an adjacent bioreactor without the need for pumping material so as to transfer material from one bioreactor to another. Suitably, each bioreactor is provided with agitation means, which keeps the contents of each bioreactor in the form of a slurry or suspension, so that solid particles are maintained in a suspended state.

The contents of each bioreactor may be also subject to heating means and, in one form, this may be provided by steam being passed into and out of each bioreactor. However, other forms of heating means may be adopted, such as electrical heating. Preferably, the temperature in each bioreactor is maintained by suitably thermostatically controlled means between 25-40° C. and, more suitably, 30-40° C.

Preferably, each anaerobic bioreactor is designed so that oxygen or air is prevented from being introduced into each of the bioreactors. Usually, the amount of dissolved oxygen will be very low and be less than 0.7 mg/l. Such bioreactors therefore may be sealed from atmosphere.

Preferably, in a first bioreactor, the pH may be in the range of 6.5-7.5 and, more suitably, 7.0. The sludge may be maintained in each bioreactor of the anaerobic bioreactor system for a period of 12-48 hours and, more preferably, 24 hours.

In the first bioreactor, a process of hydrolysis may occur to produce short chain volatile fatty acids (VFAs) such as acetic acid and propionic acids. In hydrolysis, the particulate or high molecular weight soluble substrates are broken down to smaller molecules by the incorporation of water molecules. Hydrolysis is catalysed by hydrolytic enzymes excreted by bacteria present in the biomass of the type shown in Table 2, and/or which have been added by pig and cow faeces inoculated into the bioreactor.

Subsequently, the sludge may be passed to a second bioreactor wherein acidogenesis (or acetogenesis) occurs to produce short chain volatile fatty acids (VFAs). The pH in the second bioreactor may be in the range of 5.0-6.0 and, more preferably, 5.5 due to the production of the short chain VFAs.

Subsequently, the influent may be passed to a holding cell wherein initially strong acid is added to the waste as described above to reduce the pH to 4.0-4.7 and, more suitably, 4.3. This pH may be maintained for 12-48 hours and, more preferably, 24 hours to promote the action of the free VFAs in killing bacterial pathogens.

Subsequently, a strong base, such as sodium hydroxide or potassium hydroxide, may be added to the sludge to cause a rise in pH to 7.5-9.0 and, more preferably, 8.0. Subsequently or in combination with the strong base, an alkaline earth hydroxide, such as calcium hydroxide or magnesium hydroxide may be added to the sludge to remove nitrogen and/or phosphorous.

### DESCRIPTION OF THE DRAWINGS

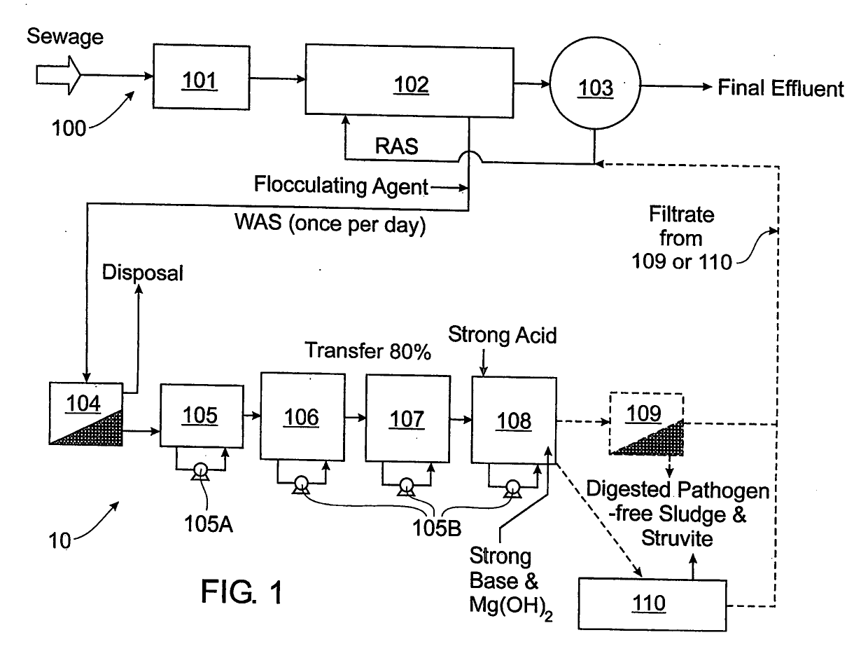

Reference may now be made to a preferred embodiment of the process of the invention as shown in FIG. 1 which refers to a pilot plant of the invention used in conjunction with a conventional BNR process.

In FIG. 1 is shown the process of the invention used in conjunction with a conventional BNR process as described previously. The treatment plant 100 used in the conventional BNR process includes sewage being fed into a screening and degritting apparatus 101 before being fed into bioreactor zone 102 which includes the four separate reactor zones described above, ie. the denitrification zone, anaerobic zone, anoxic zone and the aeration zone. Also shown are clarifiers 103. The sewage is combined with return activated sludge (RAS) and the waste activated sludge (WAS), together with addition of a flocculating agent such as polyacrylamide, is passed through pilot plant 10 of the invention which includes initial filtration by baleen filter 104. Other flocculating agents may be used such as alum ferric chloride or other substance to concentrate the solids in the WAS. The WAS has 0.4% total solids (TS) and this is increased to 2% TS after passing through filter 104. The WAS then passes through the masceration tank 105, hydrolysis fermenter 106 and acidogenesis fermenter 107 before being passed into reactor 108, wherein initially strong acid is added to the WAS before strong base and magnesium hydroxide slurry (ie. MHS). If desired, reactor 108 may be replaced by two separate reactors, if necessary.

There is also provided submersible pump 105A with cutters for processing the sludge in tank 105 as well as further submersible pumps 105B as shown.

When the sludge is in reactor 108, acid suitably in the form of industrial strength sulphuric acid may be added. This will lower the pH to around 4.0-4.7 and, more suitably, 4.3 to promote the action of the free VFAs described above in killing bacterial pathogens in the waste. This pH is maintained for a period of at least 24 hours. Preferably, 1-5 ml of acid per litre of waste is added and, more preferably, this is 1 ml/liter. Usually, the acid is industrial grade, ie. 50% strength.

After treatment with strong acid, the sludge may be subjected to a procedure in reactor 108, wherein nitrogen and/or phosphorous may be physically, chemically or biologically removed. In the case of phosphorous, magnesium hydroxide, calcium hydroxide or other alkaline earth metal hydroxide may be added to the liquid waste to cause precipitation of calcium phosphate or magnesium phosphate. In the case of simultaneous removal of both nitrogen and phosphorous, magnesium hydroxide may be added to the waste which will react with any phosphorous present as well as nitrogen present as ammonia to cause precipitation of struvite, ie. MgNH₄PO₄.6H₂O.

Nitrogen may be captured from the liquid waste by addition of a mineral acid such as sulphuric acid, which may react with any ammonia in the waste to form ammonium sulphate. Nitrogen in the form of ammonia may also be removed by nitrification followed by denitrification, eg. by means of micro-organisms.

Reference may also be made to U.S. Pat. No. 5,126,049, which is incorporated herein by reference, which described a number of methods for removal of nitrogen compounds from sludge. These include ion exchange, reversed osmosis, biological denitrification as well as precipitation of struvite.

Finally, the WAS is passed through a belt press 109 to provide final effluent comprising pathogen free sludge combined with struvite. Belt press 109 may comprise opposed fibrous belts or wringers through which the sludge passes. Alternatively, the sludge and struvite may be passed through drying beds 110 before the filtrate is passed back to BNR plant 100 as shown.

The filtrate from belt press 109 or from drying beds 110 which was returned with RAS to the beginning of the BNR sewage treatment process in FIG. 1 from treated WAS containing approx. 2% solids (wt./vol.) typically contained constituents in the stated quantities as described in Table 3 compared to the same quantities contained in typical sewage influent.

When the daily volume of the filtrate from a full scale plant of the invention (120,000 litres) containing the amounts of constituents in Table 3 is compared to the daily volume of sewage influent (12,500,000 litres) containing the amounts of constituents in Table 3, the relative percentage of each constituent being returned to the sewage influent from the process of the invention is as described in Table 4.

The following results have been achieved at a pilot plant 10 of the type shown in FIG. 1:
Fermentation of BNR sludge has produced VFAs (˜20 mM/L from 2% solids);
Faecal coliforms in the BNR sludge have been eliminated by the treatment process (5.1×10⁶ faecal coliforms reduced to undetectable levels);
95% of ortho phosphorous in the fermented sludge has been removed via struvite precipitation (300 mg/L reduced to 13.6 mg/L);
Fermentation has digested 60% of the BNR sludge BOD into fermentation end products. (BNR sludge BOD of 3,800 mg/L aerated to 1,550 mg/L)
The treated sludge is odourless;
The treated sludge is biologically stable;
The volume of sludge requiring disposal has been reduced by ˜50%;
Fermentation end products are suitable for return to BNR plant;
Belt press and sludge drying bed results are shown in Table 3.

Indicative capital costs of a pilot plant as shown in FIG. 1 to treat a daily BNR waste activated sludge stream around 450,000 litres containing about 0.4% solids are as follows:

Scenario 1: BNR Sludge @ 3% Solids
Collect sludge for treatment from Belt Press initial filter;
Treat sludge in 8×40,000 litre tanks ($50,000);
Transport sludge during treatment via 10 pumps+pipework ($25,000);
Use Acid and Alkali dosing tanks and pH monitoring equipment ($10,000);
Return treated sludge over Belt Press and collect in truck for disposal;
Vent fermentation tanks to filter trench ($5,000);
Sundries ($10,000).
Plant Capital Cost: $100,000

Scenario 2: BNR Sludge Ε 5% Solids
Collect solids from Belt Press and dilute using BNR sludge stream;
Treat sludge in 4×50,000 litre tanks ($30,000);
Transport sludge during treatment via 6 pumps+pipework ($15,000);
Use Acid and Alkali dosing tanks and pH monitoring equipment ($10,000);
Return treated sludge over Belt Press and collect in truck;
Vent fermentation tanks to filter trench ($5,000);
Contingencies ($10,000).
Plant Cost: $70,000

Plant Operating Costs (Assuming Sludge @ 3% Solids) Additives:

Acid (1 ml/L), Alkali (5 ml/L) and Magnesium Hydroxide (1 ml/L) of the volume of Reactor 108. (80,000 L @ 7 ml/L=560 Litres per day)

Cost of 560 Litres of Additive per day=˜560×$0.65 av.=$364 per day. Annual additive costs (assuming 250 days per year)=$91,000 p.a.

Sludge Disposal Costs:

Volume of stable treated sludge=10 tonnes per day. (digestion+17.7% solids compared to current 12.2% solids)

Annual local disposal of stable sludge=$19,000 p.a. (10 tonnes×250 days×$7.5 per tonne)

Plant operation overheads ˜$5,000

Annual plant operation and sludge disposal costs=˜$115,000 (current BNR sludge transport costs: 20 tonnes×$40 per tonne×250 days=$200,000 p.a.).

From the above costings, it is evident that use of the pilot plant shown in FIG. 1 is not only effective in use but will also save running costs. However, the pilot plant will also require use of pH monitoring equipment, linked to an automated acid and alkali dosing mechanism, to maintain correct pH conditions during the acidification and struvite precipitation phases of the process. Strong acid and alkali additives are required for cost effective and predictable pH control, eg. sulphuric acid and sodium hydroxide.

Annual operation costs for pilot plant shown in FIG. 1 would be ˜$115,000 p.a., approx. which is half the current cost of sludge disposal using the convention BNR plant shown in FIG. 1.

However, the major advantage offered by the process of the invention is environmentally sustainable treatment of BNR sludge.

TABLE 1

GRAM-NEGATIVE AEROBIC BACTERIA:
Acetobacter
Azospirillum brasilense
Azotobacter vinelandii
Bordetella bronchiseptica; Bordetella pertussis
Brucella abortus; Brucella melitensis
Francisella tularensis
Legionella pneumophila
Leptospira canicola; Leptospira interrogans
Acinetobacter calcoaceticus
Kingella kingae
Moraxella (Branhamella) catarrhalis; Moraxella (Moraxella) bovis
Neisseria gonorrhoeae; Neisseria meningitidis
Paracoccus denitrificans
Burkholderia cepacia; Burkholderia pseudomallei
Pseudomonas aeruginosa; Pseudomonas fluorescens;
Pseudomonas putida
Xanthomonas campestris
Agrobacterium tumefaciens
Rhizobium leguminosarum; Rhizobium meliloti
Alcaligenes
Bdellovibrio
Bradyrhizobium
Flavobacterium
Methylococcaceae

TABLE 2
ENTEROBACTERIACEAE

Members of genera belonging to the Enterobacteriaceae family
are large Gram-negative rods which are oxidase negative.
All members of this family are glucose fermenters and nitrate
reducers. There are twelve genera of the Enterobacteriaceae family.
Escherichia coli
Shigella
Edwardsiella
Salmonella
Citrobacter
Klebsiella
Enterobacter
Serratia
Proteus
Morganella
Providencia
Yersinia

TABLE 3

| | Pilot Plant 10 | (Typical Sewage Influent) |
|---|---|---|
| Constituent | Quantity (mg./L) | (Quantity (mg./L) |
| Total N (calc.) | 185.5 | 86 |
| Total N (-Nox) | 185.4 | 85 |
| Nox | 0.08 | 0.7 |
| Total P | 66.4 | 8 |
| Ortho P | 47.7 | 5 |
| BOD | 510 | 125 |
| COD | 1290 | 250 |

TABLE 4

| | % of Sewage Influent Total |
|---|---|
| | Constituent Quantities Returned via |
| Constituent | Filtrate from Pilot Plant 10 |
| Total N (calc.) | 2.2% |
| Total N (-Nox) | 2.2% |
| Nox | 0.1% |
| Total P | 0.1% |
| Ortho P | 9.5% |
| BOD | 4.1% |
| COD | 5.2% |

1. A process for treatment of waste activated sludge from a BNR process, which includes the steps of:
(a) concentration of the activated sludge from a total solids content (dry weight) of 0.1-1.0% w/v to an increased solids content of 1.5-5.0% w/v, wherein said solids largely contain bacterial biomass from prior aeration of the activated sludge;
(b) disrupting bacterial cells contained in the biomass so as to release fermentable nutrients from said bacterial cells;
(c) passing the activated sludge from step (b) through an anaerobic digester system; and
(d) removing N and/or P from the residue obtained after step (c).

2. A process as claimed in claim 1, wherein, prior to step (d), strong acid is added to the activated waste to kill bacterial pathogens.

3. A process as claimed in any preceding claim, wherein the activated sludge will have 0.4% total solids dry weight prior to step (a).

4. A process as claimed in any preceding claim, wherein the total solids dry weight in the sludge is 2-4% after step (a).

5. A process as claimed in any preceding claim, wherein the concentration step (a) is carried out in a filter comprising a screen, wherein the sludge is passed through apertures in the screen and is subject to the action of wash water above and below the screen to prevent clogging or blockages occurring in said apertures.

6. A process as claimed in any preceding claim, wherein the disruption step is carried out in a masceration pump, wherein the sludge is passed through said pump having an impeller having a cutter plate with a plurality of apertures, which is stationary with respect to a rotatable cutter axially aligned thereto.

7. A process as claimed in any one of claims 2 to 6, wherein the anaerobic bioreactor system includes a first bioreactor having a pH of 6.5-7.5.

8. A process as claimed in claim 7, wherein the pH is 7.0

9. A process as claimed in any one of claims 7 or 8, wherein there is provided a second bioreactor having a pH of 5.0-7.0.

10. A process as claimed in claim 9, wherein the pH is 5.5.

11. A process as claimed in any one of claims 2 to 10, wherein, after passage through said anaerobic bioreactor system, the activated waste is passed to another reactor, wherein the pH is reduced to 4.0-4.7.

12. A process as claimed in claim 11, wherein the pH is reduced to 4.3.

13. A process as claimed in claim 11 or 12, wherein subsequently the pH is elevated to 7.5-9.0.

14. A process as claimed in claim 13, wherein the pH is elevated to 8.0.

15. A process as claimed in claim 13 or 14, wherein an alkaline earth hydroxide is added to the activated sludge to initiate removal of P by precipitation of an alkaline earth phosphate.

16. A process as claimed in claim 15, wherein magnesium hydroxide is added to the activated waste to cause precipitation of struvite.
